(19) United States
(12) Patent Application Publication
(10) Pub. No.: US 2020/0036071 A1
(43) Pub. Date: Jan. 30, 2020

(54) GRAPHENE THERMOCELL FOR ENERGY HARVESTING DEVICE AND A PROCESS FOR MANUFACTURE THEREOF

(71) Applicant: SRM INSTITUTE OF SCIENCE AND TECHNOLOGY, Chennai, TN (US)

(72) Inventors: Harinipriya SESHADRI, Chennai (IN); Sindhuja MANI, Chennai (IN); Lohith BOLLIMUNTHA, Chennai (IN); Sudha VENKATACHALAM, Chennai (IN)

(21) Appl. No.: 16/513,066

(22) Filed: Jul. 16, 2019

(30) Foreign Application Priority Data
Jul. 25, 2018 (IN) 201841028007

(51) Int. Cl. H01M 14/00; H01M 4/583

(52) U.S. Cl. CPC H01M 14/00; H01M 4/583

(57) ABSTRACT

The present disclosure provides a graphene based thermocell for energy harvesting device and a process for manufacture thereof. The thermocell comprises a first electrode, a second electrode, and a redox electrolyte, characterized in that at least a portion of at least one of the first electrode and the second electrode is coated with graphene. The temperature difference between the first electrode and the second electrode is in the range of 40° C. to 80° C. The present disclosure also provides an energy harvesting device comprising plurality of graphene based thermocells that are electrically connected in series. The energy harvesting device is cost-effective and has a maximum energy conversion efficiency of 3.59% and maximum relative carnot efficiency of 20.2%.

### FIELD

The present disclosure relates to thermocells.

### Definitions

As used in the present disclosure, the following terms are generally intended to have the meaning as set forth below, except to the extent that the context in which they are used indicate otherwise.

A thermocell is a thermo-electrochemical system that generates electrical energy between two electrodes that have an optimum temperature difference.

A redox electrolyte refers to a liquid or gel electrolyte capable of undergoing a redox reaction.

Relative Carnot Efficiency refers to the theoretical maximum efficiency of operation of a thermocell or an energy harvesting device.

### BACKGROUND

The background information herein below relates to the present disclosure but is not necessarily prior art.

Thermocells are known to harvest electrical energy from heat via Seeback effect. Such cells are useful due to simplicity of their design, direct conversion of heat to electricity, easy maintenance and no carbon emission. Platinum electrodes are conventionally employed, however such electrodes lead to high cost and low energy conversion efficiencies. In addition, the performance of the thermocell could be affected by various forms of internal resistances such as mass transfer overpotential, activation overpotential and ohmic overpotential, wherein higher value of overpotential leads to lesser power output.

Hence, there is a need for an electrode material that is economical, enables improved charge transfer rates and has low overpotential values.

### OBJECTS

Some of the objects of the present disclosure, which at least one embodiment herein satisfies, are as follows.

An object of the present disclosure is to ameliorate one or more problems of the prior art or to at least provide a useful alternative.

Another object of the present disclosure is to provide an energy harvesting device based on a thermocell.

Another object of the present disclosure is to improve charge transfer rates and lower the internal resistances of the thermocell.

Still another object of the present disclosure is to improve the performance of the thermocell by reducing the overpotential.

Still another object of the present disclosure is to improve the energy efficiency of the thermocells.

Yet another object of the present disclosure is to provide a simple and economical process for manufacturing a thermocell.

Other objects and advantages of the present disclosure will be more apparent from the following description, which is not intended to limit the scope of the present disclosure.

### SUMMARY

In one aspect, the present disclosure provides a thermocell comprising a first electrode, a second electrode and a redox electrolyte, characterized in that at least a portion of at least one of the first electrode and the second electrode is coated with graphene. The temperature difference between the first electrode and the second electrode is in the range of 40° C. to 80° C.

Typically, the redox electrolyte is sandwiched between the first electrode and the second electrode. In an embodiment, the redox electrolyte is potassium ferricyanide solution.

In an embodiment, the concentration of the potassium ferricyanide solution is 1 molar.

The second electrode is maintained at a temperature in the range of 40° C. to 80° C. and the first electrode is maintained at a temperature in the range of 0° C. to 5° C.

The thermocell has an average maximum relative carnot efficiency of 1.3%. The thermocell has a maximum energy conversion efficiency of 1.55% at a load of 1 mV/s.

The thermocell is configured to exhibit a maximum current density of 0.63 A/m² and maximum power density of 0.18 W/m².

The thermocell is configured to exhibit an average heterogenous rate constant (Kₕₑₜ^{ohmic}) of 9.33×10¹³ s⁻¹ for ohmic process and an average heterogenous rate constant (Kₕₑₜ^{mt}) of 1.43×10¹⁶ s⁻¹ for mass-transfer process.

The first electrode and the second electrode, are partially or wholly copper electrodes, and wherein at least a portion of at least one of the first electrode and the second electrode is coated with graphene.

In another aspect, the present disclosure provides an energy harvesting device comprising a plurality of graphene based thermocells. The plurality of graphene based thermocells is electrically connected in series such that each of the plurality of graphene based thermocells are electrically connected to at least one adjacent thermocell.

The energy harvesting device has maximum energy conversion efficiency of 3.59%, maximum relative carnot efficiency of 20.2%, maximum current density of 98.3 A/m² and maximum power density of 49.2 W/m².

In still another aspect, the present disclosure provides a process for manufacturing a graphene based thermocell. The process comprises a step of oxidizing graphite to obtain graphene oxide. The graphene oxide is reacted with a reducing agent, to obtain graphene nanoparticles. The graphene nanoparticles are mixed with water to obtain a paste. The paste is coated on at least a portion of a first copper sheet, to obtain a first electrode. The paste is coated on at least a portion of a second copper sheet, to obtain a second electrode. The first electrode and the second electrode are contacted with a redox electrolyte to obtain a cell, wherein the redox electrolyte is sandwiched in between the first electrode and the second electrode. In the next step, a temperature difference in the range of 40° C. to 80° C. is maintained between the first electrode and the second electrode in the cell, and electrical connections are provided to obtain the graphene based thermocell.

In an embodiment, the temperature difference between the first electrode and the second electrode is 50° C.

The process steps are repeated to obtain a plurality of graphene based thermocells, wherein the plurality of graphene based thermocells are electrically connected in series to obtain an energy harvesting device.

### BRIEF DESCRIPTION OF THE ACCOMPANYING DRAWING

The present disclosure will now be described with the help of the accompanying drawing, in which:

FIG. 1A illustrates a schematic diagram of a thermocell 100 in accordance with the present disclosure;

FIG. 1B illustrates a first electrode 102 of FIG. 1A, in accordance with the present disclosure;

FIG. 1C illustrates a second electrode 104 of FIG. 1A, in accordance with the present disclosure;

FIG. 2A is XRD pattern for graphite used as a starting material for preparation of graphene nanoparticles;

FIG. 2B is XRD pattern for graphene oxide derived from graphite;

FIG. 2C is XRD pattern for graphene nanoparticles obtained by reduction of graphene oxide;

FIG. 3 is Linear Sweep Voltammetry (LSV) scan of the thermocell 100 at loads in the range of 1 mV/s to 100 mV/s;

FIG. 4 is an equivalent circuit of Linear Sweep Voltammetry as depicted in FIG. 3;

FIG. 5 illustrates the double layer capacitance values (C_{dl}) values at different loads in the range of 1 mV/s to 100 mV/s at ΔT=50° C.;

FIG. 6 is a graph depicting power and current density at different loads in the range of 1 mV/s to 100 mV/s at ΔT=50° C.;

FIG. 7 illustrates average mass transfer coefficient of the thermocell 100 at different loads in the range of 1 mV/s to 100 mV/s at ΔT=50° C.;

FIG. 8 illustrates energy conversion efficiency of the thermocell 100 at different loads in the range of 1 mV/s to 100 mV/s at ΔT=50° C.;

FIG. 9 illustrates relative Carnot efficiency of the thermocell 100 at different loads in the range of 1 mV/s to 100 mV/s at ΔT=50° C.;

FIG. 10 illustrates a fitted circuit diagram for the thermocell 100 at room temperature;

FIG. 11 illustrates a fitted impedance spectrum for the thermocell 100 at room temperature;

FIG. 12 illustrates an energy harvesting device 200 in accordance with the present disclosure;

FIG. 13A is Linear Sweep Voltammetry (LSV) scan of the energy harvesting device 200 at loads in the range of 1 mV/s to 100 mV/s at ΔT=60° C.;

FIG. 13B is Linear Sweep Voltammetry (LSV) scan of the energy harvesting device 200 at loads in the range of 1 mV/s to 100 mV/s ΔT=70° C., 40° C. and room temperature;

FIG. 13C is Linear Sweep Voltammetry (LSV) scan of the energy harvesting device 200 at loads in the range of 1 mV/s to 100 mV/s at ΔT=55° C.;

FIG. 13D is Linear Sweep Voltammetry (LSV) scan of the energy harvesting device 200 at loads in the range of 1 mV/s to 100 mV/s at ΔT=65° C.;

FIG. 14A illustrates average mass transfer coefficient of the energy harvesting device 200 at different loads in the range of 1 mV/s to 100 mV/s at ΔT=60° C.;

FIG. 14B illustrates average mass transfer coefficient of the energy harvesting device 200 at different loads in the range of 1 mV/s to 100 mV/s at ΔT=40° C. and 70° C.;

FIG. 14C illustrates average mass transfer coefficient of the energy harvesting device 200 at different loads in the range of 1 mV/s to 100 mV/s at ΔT=55° C. and 65° C.;

FIG. 15A illustrates Nyquist plot for the energy harvesting device 200 at ΔT=60° C.;

FIG. 15B illustrates Nyquist plot for the energy harvesting device 200 at ΔT being room temperature;

FIG. 15C illustrates Nyquist plot for the energy harvesting device 200 at ΔT=40° C., 50° C., 70° C. and 80° C.;

FIG. 15D illustrates Nyquist plot for the energy harvesting device 200 at ΔT=55° C. and 65° C.;

FIG. 16A illustrates Bode plot for the energy harvesting device 200 at ΔT=60° C.;

FIG. 16B illustrates Bode plot for the energy harvesting device 200 at ΔT=being room temperature;

FIG. 16C illustrates Bode plot for the energy harvesting device 200 at ΔT=40° C.;

FIG. 16D illustrates Bode plot for the energy harvesting device 200 at ΔT=50° C.;

FIG. 17A illustrates Bode plot for the energy harvesting device 200 at ΔT=70° C.;

FIG. 17B illustrates Bode plot for the energy harvesting device 200 at ΔT=80° C.;

FIG. 17C illustrates Bode plot for the energy harvesting device 200 at ΔT=55° C.;

FIG. 17D illustrates Bode plot for the energy harvesting device 200 at ΔT=65° C.;

FIG. 18 illustrates fitted equivalent circuit for the bode and nyquist plots for the energy harvesting device 200 at ΔT=60° C.;

FIG. 19A illustrates constant phase element at electrode/electrolyte interface at room temperature;

FIG. 19B illustrates constant phase element at electrode/electrolyte interface for ΔT=40° C., 50° C., 70° C., 80° C.;

FIG. 20A illustrates the energy conversion efficiency and the carnot efficiency of the energy harvesting device 200 at different load values from 1 mV/s to 100 mV/s at ΔT=60° C.;

FIG. 20B illustrates the energy conversion efficiency of the energy harvesting device 200 at different load values from 1 mV/s to 100 mV/s at ΔT=40° C. and 70° C.;

FIG. 20C illustrates the energy conversion efficiency of the energy harvesting device 200 at different load values from 1 mV/s to 100 mV/s at ΔT=55° C. and 65° C.;

FIG. 21A illustrates the carnot efficiency of the energy harvesting device 200 at different load values from 1 mV/s to 100 mV/s at ΔT=40° C. and 70° C.;

FIG. 21B illustrates the carnot efficiency of the energy harvesting device 200 at different load values from 1 mV/s to 100 mV/s at ΔT=55° C. and 65° C.;

FIG. 22A illustrates X-ray diffraction (XRD) of energy harvesting device (200) comprising used graphene coated electrodes and of electrolyte at ΔT=60° C.;

FIG. 22B illustrates cyclic voltammogram of a reference electrode, an energy harvesting device (200) comprising fresh graphene coated electrodes and an energy harvesting device (200) comprising used graphene coated electrodes at ΔT=60° C.;

FIG. 23A illustrates cyclic voltammogram of a reference electrode (bare copper) at ΔT=40° C., 50° C. and 70° C.;

FIG. 23B illustrates cyclic voltammogram of graphene coated electrodes at ΔT=40° C., 50° C., 70° C. and 80° C.; and

FIG. 24 illustrates graphene coating on copper sheets as electrodes with thickness of (a) 20 μm and (b) 30 μm.

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

When an element is referred to as being “mounted on,” “engaged to,” “connected to,” or “coupled to” another element, it may be directly on, engaged, connected or coupled to the other element. As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Terms such as “inner,” “outer,” “beneath,” “below,” “lower,” “above,” “upper,” and the like, may be used in the present disclosure to describe relationships between different elements as depicted from the figures.

The choice for an electrode material in a thermocell affects various internal resistances such as mass transfer overpotential, activation overpotential and ohmic overpotential. Conventionally, platinum electrodes have been employed. However, these electrodes are expensive and lead to low energy conversion efficiencies.

In comparison to conventional electrode materials, carbon nanomaterials based electrodes in thermocells offer advantages of fast redox processes, high thermal and electrical conductivities, high gravimetric surface area and higher energy conversion efficiency. Carbon nanomaterials as electrodes exhibit low activation overpotential between the electrodes and aqueous electrolyte, which is an important aspect in improving the thermocell performance. The present disclosure employs graphene as a suitable carbon nanomaterial for use in electrodes for thermocells.

The present disclosure provides a graphene thermocell and a process of manufacturing thereof. The graphene thermocell is relatively cost-effective than conventional platinum based electrodes, and has improved performance and energy efficiency.

In addition, the present disclosure also provides an energy harvesting device to achieve improved efficiencies by connecting such thermocells in series for better energy harvesting.

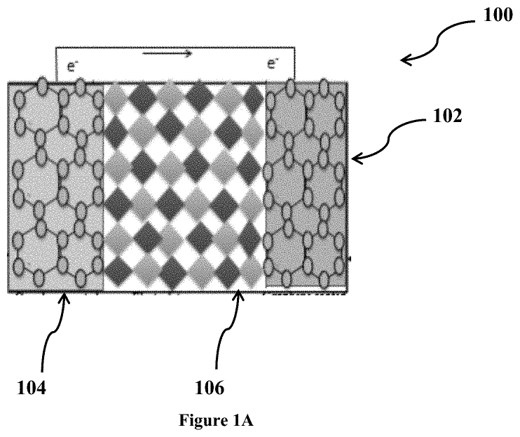

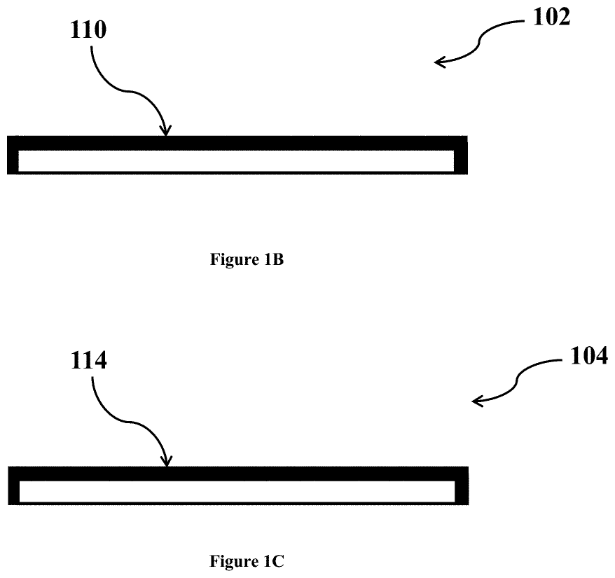

In one aspect and with reference to FIG. 1A, the present disclosure provides a thermocell 100 for converting waste heat into electrical energy. The thermocell 100 comprises a first electrode 102, a second electrode 104 and a redox electrolyte 106. In accordance with an embodiment and with reference to FIG. 1B, at least a portion 110 of the first electrode 102 is coated with graphene. In accordance with another embodiment and with reference to FIG. 1C, at least a portion 114 of the second electrode 104 is coated with graphene. Typically, the first electrode 102 and the second electrode 104, partially or wholly, are copper electrodes and wherein at least a portion 110, 114 of at least one of the first electrode 102 and the second electrode 104 is coated with graphene. Typically, the thermocell 100 is assembled in such a way that the redox electrolyte 106 is sandwiched between the first electrode 102 and the second electrode 104. The assembly is further sealed and provided with copper leads from each side of the electrodes for enabling electrical connections.

The material for the thermocell 100 is prepared by using graphite as a raw material, wherein graphite is transformed to graphene oxide using conventional methods. Typically, graphite is converted to graphene oxide using modified Hummers method. Hummers method is commonly used to generate graphite oxide by adding potassium permanganate to a mixture of graphite, sodium nitrate, and sulfuric acid. Graphene material for electrode is formed by reduction of graphene oxide using reducing agents. Typically, an aqueous dispersion of graphene is heated with hydrazine hydrate and ammonia, wherein the brown-coloured aqueous dispersion of graphene transforms to a black colored dispersion. The black colored dispersion is filtered and washed with water. The filtered product is dried under continuous flow of water to obtain graphene nanoparticles.

The preparation of electrodes for the thermocell is done by coating the synthesized graphene nanoparticles on a copper sheet of a pre-determined shape and dimension. In an embodiment, the graphene nanoparticles are mixed with water to transform into a paste which is then applied to the copper sheet and allowed to dry for 2-3 hours. In an embodiment, two such copper sheets coated with graphene are used as the first electrode 102 and the second electrode 104.

The redox electrolyte 106 for the thermocell 100 is prepared by mixing agar-agar powder with water, followed by addition of potassium ferricyanide solution. Typically, 5 g of agar-agar is mixed with 50 ml of water to obtain a mixture. Typically, the concentration of potassium ferricyanide is 1 Molar. The mixture is heated at 80° C. till it forms a gel.

The operation of the thermocell 100 requires the first electrode 102 and the second electrode 104 to have a temperature difference (ΔT). Typically, the temperature difference (ΔT) between the first electrode 102 and the second electrode 104 is in the range of 40° C. to 80° C.

In an exemplary embodiment, the temperature difference between the first electrode (102) and the second electrode (104) is 50° C.

In an embodiment the temperature difference (ΔT) between the first electrode 102 and the second electrode 104 is 50° C. In accordance with the present disclosure, the second electrode 104 is maintained at a temperature in the range of 40° C. to 80° C. whereas the first electrode 102 is maintained at a temperature in the range of 0° C. to 5° C. During operation of the cell, the second electrode 104 which is maintained at a higher temperature acts as anode, whereas the second electrode 104 which is maintained at lower temperature acts as cathode. The temperature difference (ΔT) between the first electrode 102 and the second electrode 104 causes a difference in the redox potential of the electrolyte at the electrodes 102 and 104 thus causing generation of electricity and thereby movement of electrons from the second electrode 104 towards the first electrode 102 in the external circuit.

In an embodiment, the temperature difference (ΔT) is achieved by placing the thermocell 100 on a hotplate such that one of the electrodes is in contact with the hotplate, wherein the hotplate is maintained at a temperature of 40 to 80° C. Further, frozen silica gel is placed over the thermocell 100 such that the other electrode is in contact with the frozen silica gel thereby maintaining it at a temperature in the range of 0 to 5° C.

The thermocell 100 is subjected to measurement of current vs voltage (I-V) profile at different loads and ΔT=50° C. by connecting the copper leads provided on the electrodes to an electrochemical workstation.

In another aspect, the present disclosure provides an energy harvesting device comprising a plurality of graphene based thermocells. Each of the plurality of graphene based thermocells comprises a first electrode (102), a second electrode (104), and a redox electrolyte (106). Each of the plurality of graphene based thermocells is characterized in that at least a portion (110 and 114) of at least one of the first electrode (102) and the second electrode (104) is coated with graphene, wherein the temperature difference between the first electrode (102) and the second electrode (104) is in the range of 40° C. to 80° C.

In an exemplary embodiment, the temperature difference between the first electrode (102) and the second electrode (104) is 50° C.

The plurality of graphene based thermocells are electrically connected in series such that each of the plurality of graphene based thermocells have electrical connection to at least one adjacent thermocell.

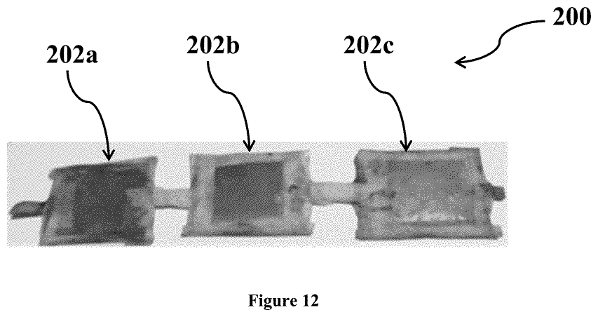

In an embodiment, the energy harvesting device 200 comprises three graphene based thermocells (200a, 200b and 200c) connected in series, as illustrated in FIG. 12. The three graphene based thermocells (200a, 200b and 200c) are connected in series in such a way that the input heat flux from the hotter cell is transferred to the adjacent cell.

The energy harvesting device 200 is subjected to the measurement of current vs voltage (I-V) profile at different loads and ΔT=60° C. by connecting the copper leads provided on the electrodes to an electrochemical workstation.

The energy harvesting device 200 has maximum energy conversion efficiency of 3.59%, maximum relative carnot efficiency of 20.2%, maximum current density of 98.3 A/m² and maximum power density of 49.2 W/m².

In still another aspect, the present disclosure provides a process for manufacturing a graphene based thermocell (100).

The process comprises a step of oxidizing graphite to obtain graphene oxide.

In an embodiment, the step of oxidation comprises reacting graphite with sodium nitrite, sulphuric acid and potassium permanganate.

In an exemplary embodiment, graphite is mixed with a predetermined amount of sodium nitrite, concentrated sulphuric acid and potassium permanganate and stirred for a time period of 2 hours, to obtain a mixture. The mixture is maintained for 3 days, followed by dilution with water to obtain a brown colored solution. The solution is further diluted with water, followed by the addition of 30% hydrogen peroxide to obtain a bright yellow colored dispersion. The dispersion is filtered to obtain graphene oxide.

In the next step, the graphene oxide is reacted with a reducing agent, to obtain graphene nanoparticles.

In an embodiment, the reducing agent is hydrazine hydrate.

In an exemplary embodiment, the graphene oxide is mixed with water to obtain a dispersion. A predetermined amount of hydrazine hydrate and ammonia solution is added to the dispersion and heated at 100° C. for 3 hours to obtain a reaction mixture, which shows a color change from brown to black color. The reaction mixture is refluxed for 12 hours to obtain slurry. The slurry is filtered to obtain a cake which is washed with water to remove excess of hydrazine hydrate. The washed cake is dried under air flow to obtain graphene nanoparticles.

Further, the graphene nanoparticles are mixed with water to obtain a paste. The paste is coated on at least a portion of a first copper sheet, to obtain a first electrode (102). In the next step, the paste is coated on at least a portion of a second copper sheet, to obtain a second electrode (104).

Further, the first electrode (102) and the second electrode (104) are contacted with a redox electrolyte (106) to obtain a cell, wherein the redox electrolyte is sandwiched in between the first electrode (102) and the second electrode (104).

In an embodiment, the redox electrolyte is prepared by mixing agar powder with water and potassium ferricyanide, at a temperature in the range of 75° C. to 85° C.

In the next step, a temperature difference is maintained between the first electrode (102) and the second electrode (104) in the cell, and electrical connections are provided to obtain the graphene based thermocell (100).

The temperature difference is in the range of 40° C. to 80° C. In an exemplary embodiment, the temperature difference is 50° C.

The process steps are repeated to obtain a plurality of graphene based thermocells.

In an embodiment, the plurality of graphene based thermocells are electrically connected in series to obtain an energy harvesting device (200), wherein each of the plurality of graphene based thermocells is electrically connected to at least one adjacent thermocell.

The graphene thermocell of the present disclosure is relatively cost-effective than conventional platinum based electrodes, and has improved performance and energy efficiency.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The present disclosure is further described in light of the following laboratory scale experiments, which are set forth for illustration purpose only and not to be construed for limiting the scope of the disclosure. These laboratory scale experiments can be scaled up to industrial/commercial scale and the results obtained can be extrapolated to industrial/commercial scale.

### Experiment 1: Preparation of Material and the Graphene Thermocell

1a) Synthesis of Graphene Oxide (GO) from Graphite (by Modified Hummers Method):

Graphite powder (1 g) was mixed with sodium nitrite (0.76 g), concentrated sulphuric acid (34 ml) and potassium permanganate (4.5 g). The mixture was stirred for 2 hours and then kept standing for 3 days at room temperature. The mixture was diluted with water (46 ml) to obtain a brown colored solution. The brown colored solution was further diluted with 140 ml of water, followed by the addition of 30% H₂O₂ to obtain a bright yellow colored dispersion. Finally the dispersion was filtered to isolate graphene oxide.

1b) Synthesis of Graphene Nanoparticles from Graphene Oxide (GO):

Graphene oxide (100 mg) as obtained in step (a) was mixed with water (100 ml) in a 250 ml round bottomed flask to obtain a homogenous brown dispersion. Hydrazine hydrate (1 ml) and ammonia solution were added to the graphene oxide dispersion and the mixture was heated in an oil bath at 100° C. under a water-cooled condenser for 3 hours. The addition of hydrazine hydrate led to the reduction of graphene oxide, thereby changing the color of the dispersion from brown to black. The dispersion was refluxed for 12 hours, followed by filtration. The filtered cake of reduced graphene oxide was then washed with water to remove excess of hydrazine. The filtered cake was then dried under continuous air flow to obtain graphene nanoparticles.

### 1c) Preparation of Electrodes 102 and 104:

A copper sheet was taken and cut into required shape of 5 cm×5 cm dimension and cleaned with nitric acid to eliminate contaminants and oxides. Graphene nanoparticles (5 g) as obtained in step (b) were taken and mixed well with distilled water in the form of paste. The paste was applied to two cleaned copper sheets using a paint brush and allowed to dry for 2-3 hours to form graphene coated electrodes 102 and 104.

### 1d) Preparation of Redox Electrolyte for the Thermocell:

Agar-agar powder (5 g) was mixed with water followed by addition of potassium ferricyanide (1M). The mixture was stirred at 80° C. until gel was formed.

### 1e) Fabrication and Operation of the Thermocell:

The redox electrolyte (as prepared in example (d)) was sandwiched between two sheets of electrodes coated with graphene (electrodes 102 and 104 as prepared in example (c)). Each of the electrodes was also provided with copper leads. The electrolyte and the electrodes were sealed with M-seal to obtain the graphene based thermocell. For the operation of the thermocell, electrodes 102 and 104 were maintained at different temperatures such that the temperature difference (ΔT) is at least 50° C. To achieve this, the thermocell 100 was placed on a hotplate such that one of the electrodes is in contact with the hotplate, wherein the hotplate was maintained at a temperature of 40 to 80° C. Frozen silica gel was placed over the thermocell 100 such that other electrode was in contact with the frozen silica gel thereby maintaining it at a temperature of 0 to 5° C.

The copper leads provided on each electrode were connected to Ivium electrochemical workstation. The thermocell 100 was subjected to measurement of I-V profile at ΔT=50° C. The temperature difference (ΔT) between the first electrode 102 and second electrode 104 caused a difference in the redox potential of the electrolyte at the electrodes, thus allowing power generation. The electrons extracted at anode by oxidation of ferro/ferricyanide traveled through external circuit to be consumed at cathode via reduction of ferri/ferrocyanide. This electrochemical pathway that the thermocells utilize to attain energy conversion allowed continuous operation of the device.

### Experiment 2: Characterization of Graphene Nanoparticles and Starting Material by XRD

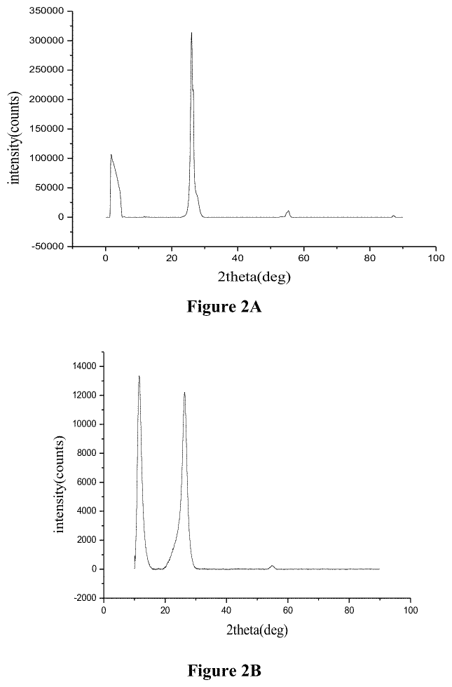

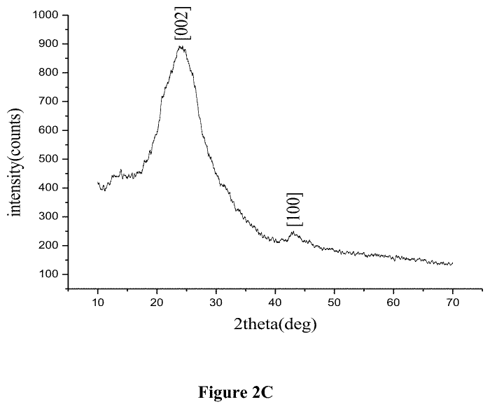

FIGS. 2A, 2B and 2C depict XRD pattern for graphite, graphene oxide and graphene nanoparticles, respectively. As shown in FIG. 2A, pristine graphite has a strong and sharp diffraction peak at 26.38°, corresponding to the highly organized layer structure with an interlayer distance of 0.34 nm along the (002) plane orientation. After the oxidation, a new peak is found at 11.95° with (001) plane thereby indicating an increase in d-spacing from 0.34 nm to 0.82 nm for graphene oxide as shown in FIG. 2B. An increased interlayer distance between consecutive carbon basal planes is attributed to the intercalation of oxygen functional groups and water molecules into carbon layer structure. Such a large shift towards lower angle is due to the introduction of water into interlayers of graphene oxide. As shown in FIG. 2C, XRD exhibits a broad peak at 25.48° for graphene nanoparticles. The crystallite size of graphene nanoparticles is 1.38 nm as calculated using Debye Scherrer formula.

### Experiment 3: Analysis of Thermocell:

### 3a) Linear Sweep Voltammetry (LSV):

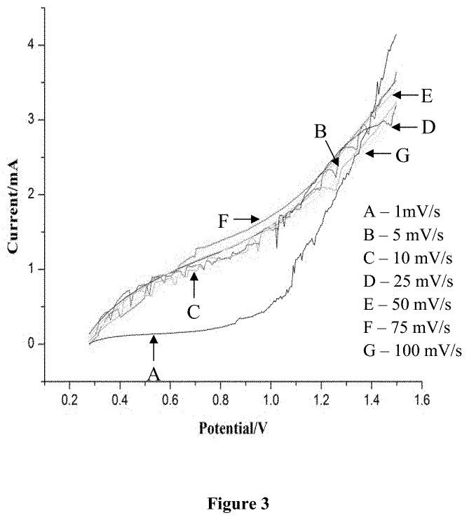

FIG. 3 is Linear Sweep Voltammetry (LSV) scan of the thermocell at loads in the range of 1 mV/s to 100 mV/s. The I-V profile in the scan shows maximum current obtained from the device as 4 mA at 1 mV/s and the maximum voltage output as 0.3V at all loads. The value of current is very small and constant at load of 1 mV/s in the range of potential 0 Volt to 1 Volt. This constant plateau in current at 1 mV/s is due to the continuous flow of electrons required to maintain a charged electric double layer at the electrode/electrolyte interface. Beyond 1 Volt, the electrochemical redox reaction occurs at the electrode/electrolyte interface leading to a rapid increase in current. These results indicate that copper electrode coated with graphene increases the phononic vibrations and electron mobility at electrode/electrolyte interface owing to the high conductivity of graphene.

### 3b) Equivalent Circuit Diagram Based on Linear Sweep Voltammetry (LSV):

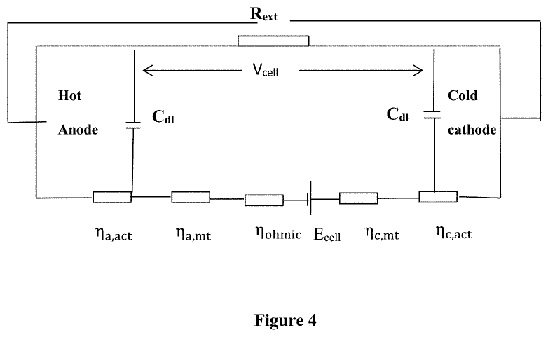

FIG. 4 illustrates an equivalent circuit of Linear Sweep Voltammetry as depicted in FIG. 3. The equivalent circuit includes various types of internal resistance or overpotentials comprising ohmic overpotential (η_{ohmic}), double layer capacitance (C_{dl}), activation overpotential (η_{act}) and mass transfer overpotential (ηₘₜ). The ohmic overpotential (η_{ohmic}) is mainly due to electrolyte resistance rather than electrode resistance whereas the mass transfer overpotential (ηₘₜ) is due to transport of the reaction product from one electrode to another electrode. The double layer capacitance (C_{dl}) is a result of the accumulation of charges at electrolyte/electrode interface.

### 3c) Cell Voltage Equation and Estimation of Overpotential:

The cell voltage equation is written as below based on the equivalent circuit model as given in FIG. 3,

V_{cell}=IRₑₓₜ;

wherein Rₑₓₜ is the external resistance.

Since, V=E−η, where η=overpotential, the cell voltage can be expressed as

V_{cell}=E_{cell}−(ηₘₜ−η_{ohmic}+η_{act})

In the present disclosure, the activation overpotential can be neglected owing to the fast redox reactions and electron transfer at the electrode/electrolyte interface. This is mainly due to the electron rich nature of graphene material and due to the use of a saturated solution of potassium ferricyanide (1M).

### 3d) Estimation of Ohmic Overpotential:

The ohmic overpotential is calculated using

η_{ohmic}=IRᵢₙₜ

wherein Rᵢₙₜ is the internal resistance.

Further, the free energy of activation for the ohmic process (ΔG^{#}_{ohmic}) is calculated using,

ΔG_{ohmic}^{#}=−nFη_{ohmic}

Referring to the Arrhenius equation, the heterogenous rate constant (K_{bet}^{ohmic}) is calculated using,

$${K}_{het}^{ohmic} = \frac{{k}_{b} T}{h} exp \{ \frac{- Δ {G}_{ohmic}^{\#}}{RT} \}$$

The calculated values of ohmic overpotential (η_{ohmic}), free energy of activation for the ohmic process (ΔG^{#}_{ohmic}) and heterogenous rate constant (Kₕₑₜ^{ohmic}) for different loads are provided in Table 1, wherein these variables do not show any significant change with increase in load. The ohmic overpotential (η_{ohmic}) being low in value indicates high ionic conductivity at electrode/electrolyte interface. Further, the average value for free energy of activation (ΔG^{#}_{ohmic}) is −7.06 kJ/mol, wherein the negative value implies the spontaneity of the process. Furthermore, the average heterogenous rate constant (Kₕₑₜ^{ohmic}) is 9.33×10¹³ s⁻¹, thereby indicating faster transport of ions at electrode/electrolyte interface.

Table 1 provides the values for ohmic overpotential (ηohmic), free energy of activation for the ohmic process (ΔG#_{ohmic}) and heterogenous rate constant (Kₕₑₜ^{ohmic}) at different loads in the range of 1mV/s to 100mV/s at ⋄T=50° C.

| Load in | η_{ohmic} | ΔG_{ohmic}^{#} | Kₕₑₜ^{ohmic} | |
|---|---|---|---|---|
| mV/s | in V | in J/mol | in s⁻¹ | Rₒₕₘ in Ω |
| 1 | 0.0732 | −7063.8 | 9.334 × 10¹³ | 18.8 |
| 5 | 0.0731 | −7054.2 | 9.302 × 10¹³ | 20.8 |
| 10 | 0.0731 | −7054.2 | 9.302 × 10¹³ | 23.5 |
| 25 | 0.0732 | −7063.8 | 9.334 × 10¹³ | 24.4 |
| 50 | 0.0733 | −7073.4 | 9.368 × 10¹³ | 22.2 |
| 75 | 0.0731 | −7054.2 | 9.302 × 10¹³ | 20.8 |
| 100 | 0.0732 | −7063.8 | 9.334 × 10¹³ | 24.4 |

### 3e) Estimation of Mass Transfer Overpotential:

The equation for calculating mass transfer overpotential (ηₘₜ), as derived from the prior stated equations is given as,

ηₘₜ=E_{cell}−I(Rₑₓₜ+Rᵢₙₜ)

The above equation was re-written using Nernst equation to give,

ηₘₜ=E⁰+0.025 ln(1M/2 mM)−I(Rₑₓₜ+Rᵢₙₜ)

By using standard redox potential of electrolyte (E°) as 0.36V and using the experimentally derived values of Rᵢₙₜ and Rₑₓₜ, the mass overpotential can be written as

ηₘₜ=0.5133−I(Rₑₓₜ+Rᵢₙₜ)

Using the above equation the mass transfer overpotential (ηₘₜ) is calculated. The free energy of activation for the mass transfer process (ΔG^{#}ₘₜ) and heterogenous rate constant (Kₕₑₜ^{mt}) are calculated in a similar way as that for ohmic process. The calculated values of mass transfer overpotential (ηₘₜ), free energy of activation for the mass transfer process (ΔG^{#}ₘₜ) and heterogenous rate constant (Kₕₑₜ^{mt}) for different load are provided in Table 2, wherein these variables do not show any significant change with increase in load. The mass transfer overpotential (ηₘₜ), being low in value indicates good redox kinetics at electrode/electrolyte interface. Further, the average value for free energy of activation (ΔG^{#}ₘₜ) is −20.5 KJ/mol wherein the negative value implies the spontaneity of the process. Furthermore, the average heterogenous rate constant (Kₕₑₜ^{mt}) is 1.43×10¹⁶ s⁻¹, thereby indicating faster transport of redox species towards copper electrodes coated with graphene. Table 2 provides the values for mass transfer overpotential (ηmt), free energy of activation for the mass transfer process (ΔG#ₘₜ) and heterogenous rate constant (Kₕₑₜ^{mt}) at different loads in the range of 1mV/s to 100mV/s at ΔT=50° C.

| Load in | ηₘₜ | ΔGₘₜ^{#} | Kₕₑₜ^{mt} | |
|---|---|---|---|---|
| mV/s | in V | in J/mol | in sec⁻¹ | Rₘₜ in Ω |
| 1 | 0.2133 | −20583.4 | 1.431 × 10¹⁶ | 53.3 |
| 5 | 0.2134 | −20593.1 | 1.435 × 10¹⁶ | 60.9 |
| 10 | 0.2135 | −20602.7 | 1.441 × 10¹⁶ | 68.8 |
| 25 | 0.2133 | −20583.4 | 1.431 × 10¹⁶ | 71.1 |
| 50 | 0.2133 | −20583.4 | 1.431 × 10¹⁶ | 64.6 |
| 75 | 0.2134 | −20593.1 | 1.435 × 10¹⁶ | 60.9 |
| 100 | 0.2133 | −20583.4 | 1.431 × 10¹⁶ | 71.1 |

### 3f) Double Layer Capacitance (C_{dl}):

The values for double layer capacitance (C_{dl}) are calculated using the formula,

$$\frac{{I}_{a} - {I}_{c}}{2} = {C}_{dl} \frac{dE}{dt}$$

FIG. 5 illustrates the double layer capacitance values (C_{dl}) values plotted at different loads in the range of from 1 mV/s to 100 mV/s at ΔT=50° C. The drop in the double layer capacitance value of 3.72 F at load of 1 mV/s to 0.32 F at load of 100 mV/s could be attributed to the high charge separation at low load (higher relaxation time of the system) and vice versa at higher load. The increase in load causes decrease in capacitance thereby resulting in faster transport of ions/electrons with no queuing of ions/electrons at the electrode-electrolyte interface, thus resulting in lower C_{dl} values.

Table 3 provides C_{dl} Values at different loads in the range of 1mV/s to 100mV/s at ΔT=50° C.

| | Double layer |
|---|---|
| Load in mV/s | capacitance in F |
| 1 | 3.72 |
| 5 | 2.48 |
| 10 | 1.25 |
| 25 | 0.80 |
| 50 | 0.31 |
| 75 | 0.33 |
| 100 | 0.32 |

3g) Power Density (Pₘₐₓ/A) and Current Density (J_{sc}):

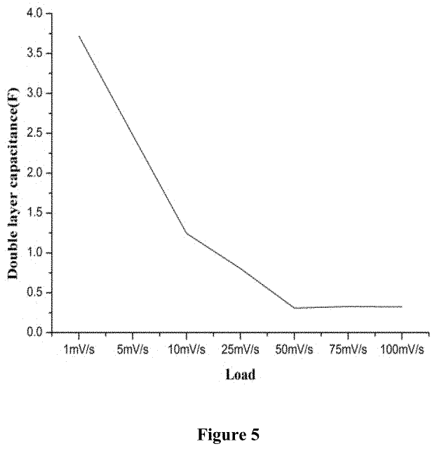

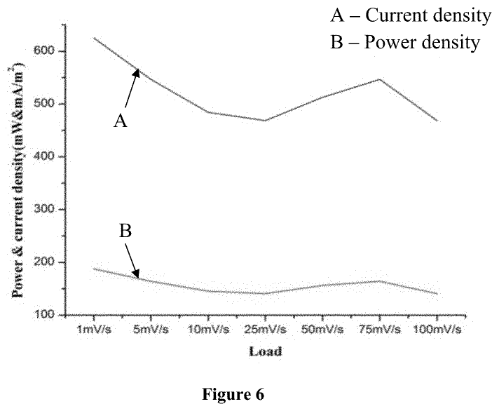

FIG. 6 is a plot depicting power density (Pₘₐₓ/A) and current density (J_{sc}) at different loads in the range of 1 mV/s to 100 mV/s at ΔT=50° C. The trend of change in power and current density with respect to load is identical. The values for maximum current density and power density obtained are 0.63 A/m² and 0.18 W/m², respectively at ΔT=50° C. which are comparable with the existing thermocells in the art.

Table 4 provides a graph of power density and current density vs Load

| Load in | | E_{oc} | | | |
|---|---|---|---|---|---|
| mV/s | J_{sc} (mA/m²) | (V) | I_{sc} (mA) | Pₘₐₓ (mW) | Pₘₐₓ/A (mW/m²) |
| 1 | 625 | 0.3 | 4 | 1.2 | 187.5 |
| 5 | 546.8 | 0.3 | 3.5 | 1.05 | 164.0 |
| 10 | 484.3 | 0.3 | 3.1 | 0.93 | 145.3 |
| 25 | 468.5 | 0.3 | 3 | 0.9 | 140.6 |
| 50 | 512.62 | 0.3 | 3.3 | 1 | 156.25 |
| 75 | 546.8 | 0.3 | 3.5 | 1.05 | 164.0 |
| 100 | 468.5 | 0.3 | 3 | 0.9 | 140.6 |

### 3h) Mass Transfer Coefficient:

The mass transfer coefficient indicates the effectiveness of ion transport. The mass transfer coefficient (k_{c}) is calculated from the dependence of limiting current on electrolyte concentration by exploiting the limiting current method and using the following equation,

k_{c}=i_{L}/nFAC_{∞}

where i_{L} is the limiting current, n is the number of moles of electrons transferred, F is the faraday constant, A is the electrode area and C_{∞} is the bulk species concentration.

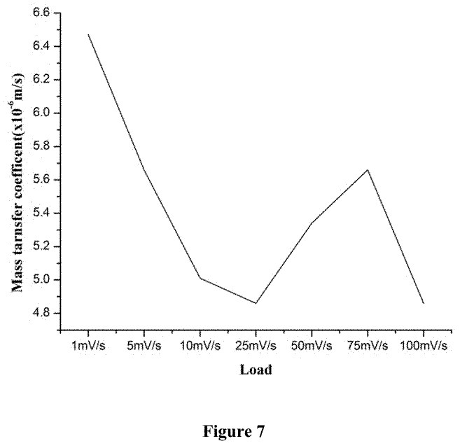

FIG. 7 illustrates the average mass transfer coefficient of the thermocell at different loads in the range of 1 mV/s to 100 mV/s at ΔT=50° C. The average mass transfer coefficient of the thermocell is 5.41×10⁻⁶ m/s at ΔT=50° C. This value of mass transfer co-efficient is comparable or higher than several existing thermocells in the art thereby indicating faster electron transport in redox mediator system.

Table 5 provides values for average mass transfer coefficient of the thermocell at different load in the range of 1mV/s to 100mV/s at ΔT=50° C.

| Load in mV/s | Mass Transfer Coefficient, m/s |
|---|---|
| 1 | 6.47 × 10⁻⁶ |
| 5 | 5.66 × 10⁻⁶ |
| 10 | 5.01 × 10⁻⁶ |
| 25 | 4.86 × 10⁻⁶ |
| 50 | 5.34 × 10⁻⁶ |
| 75 | 5.66 × 10⁻⁶ |
| 100 | 4.86 × 10⁻⁶ |

### 3i) Energy Conversion Efficiency (η):

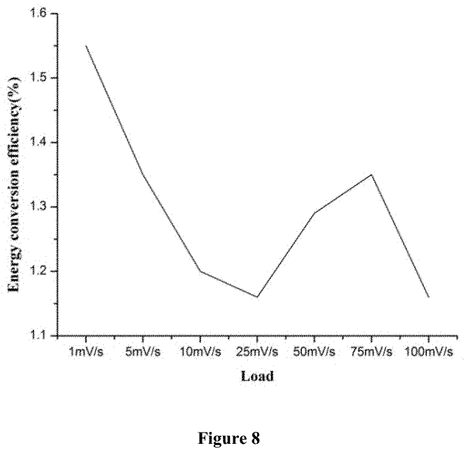

The energy conversion efficiency (η) of the thermocells is calculated using

$$η = \frac{( 1 / 4 ) {V}_{OC} \cdot {I}_{SC}}{{A}_{C} κ ( Δ T / d )}$$

where V_{OC} is the open-circuit voltage, I_{sc} is the short circuit current, A is the cross-sectional area of the cell, κ is the thermal conductivity of the electrolyte, ΔT is the temperature difference between the electrodes and d is the electrode separation distance. FIG. 8 illustrates the energy conversion efficiency of the thermocell at different load values from 1 mV/s to 100 mV/s at ΔT=50° C. The parameters employed are V_{OC}=0.1V, Iₛₑ=5 mA, A=0.0064 m², κ=0.57 w/m/k, ΔT=50° C., d=0.6 cm. The maximum energy conversion efficiency for the thermocell is 1.55% at load of 1 mV/s.

Table 6 provides the values for energy conversion efficiency of the thermocell at different loads in the range of 1mV/s to 100mV/s at ΔT=50° C.

| Load in mV/s | Energy conversion efficiency % |
|---|---|
| 1 | 1.55 |
| 5 | 1.35 |
| 10 | 1.2 |
| 25 | 1.16 |
| 50 | 1.29 |
| 75 | 1.35 |
| 100 | 1.16 |

### 3j) Relative Carnot Efficiency (ηᵣ):

The energy conversion efficiency relative to the Carnot efficiency of a heat engine (ηᵣ) is

ηr=η/(ΔT/T_{H})

where is the T_{H} hot electrode temperature

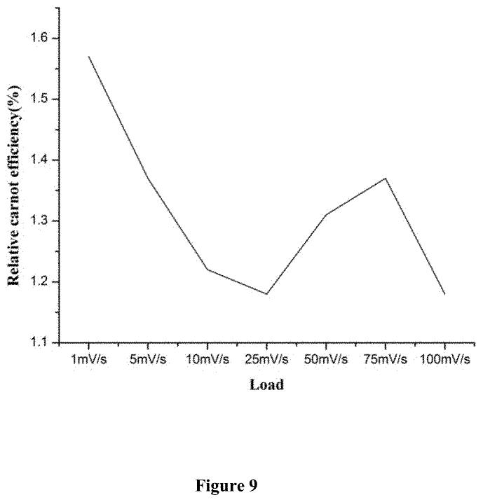

FIG. 9 illustrates the relative carnot efficiency of the thermocell at different loads in the range of 1 mV/s to 100 mV/s at ΔT=50° C. The resulting average maximum relative carnot efficiency is ηᵣ=1.31% at ΔT=50° C. for the thermocell which is higher than several existing thermo-cells in the art.

Table 7 provides the values for relative carnot efficiency of thermocell at different loads in the range of 1mV/s to 100mV/s at ΔT=50° C.

| | Relative carnot |
|---|---|
| Load in mV/s | efficiency % |
| 1 | 1.57 |
| 5 | 1.37 |
| 10 | 1.22 |
| 25 | 1.18 |
| 50 | 1.31 |
| 75 | 1.37 |
| 100 | 1.18 |

### 3k) Estimation of Ohmic and Mass Transfer Resistance:

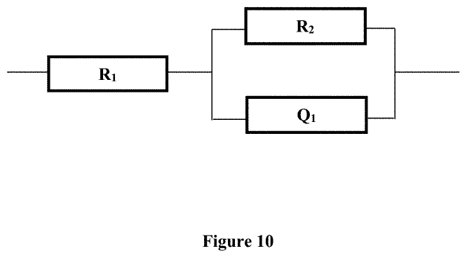

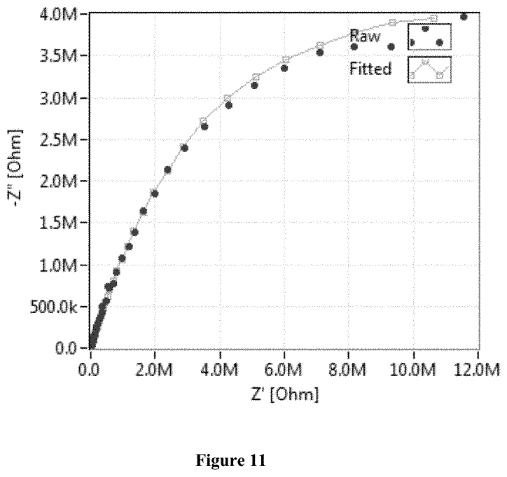

FIG. 10 illustrates a fitted Circuit diagram for the thermocell at room temperature and FIG. 11 illustrates a fitted impedance spectrum for the thermocell at room temperature. The constant phase element Q in FIG. 10 is attributed to inhomogeneous surface of the electrodes and R₁ is mass transfer resistance. The CPE (Q) is used to explain the depression of the capacitance semicircle, which corresponds to surface heterogeneity resulting from surface roughness, impurities, dislocations, grain boundaries and formation of porous layers. The average ohmic and mass transfer resistance is reduced at ΔT=50° C. to 19.2Ω and 64.4Ω. This implies that faster phononic vibrations and redox behavior occur when the temperature increases.

### Experiment 4: Preparation of Energy Harvesting Device (200)

The method as provided in Experiment 1e was repeated to obtain three graphene based thermocells. The thermocells so obtained were electrically connected in series to obtain an energy harvesting device (200) as shown in FIG. 12, such that the input heat flux from the hotter cell is transferred to the adjacent cell.

The energy harvesting device (200) was subjected to analytical measurements including Linear Sweep Voltammetry (LSV), measurement of mass transfer coefficient, Electrochemical Impedance Spectroscopy (EIS) and degradation studies.

### Experiment 5: Analysis of Energy Harvesting Device (200):

### 5a) Linear Sweep Voltammetry (LSV):

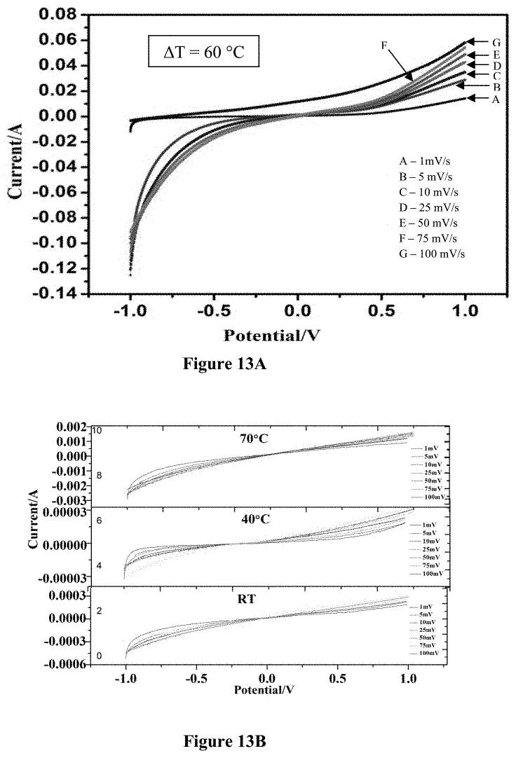

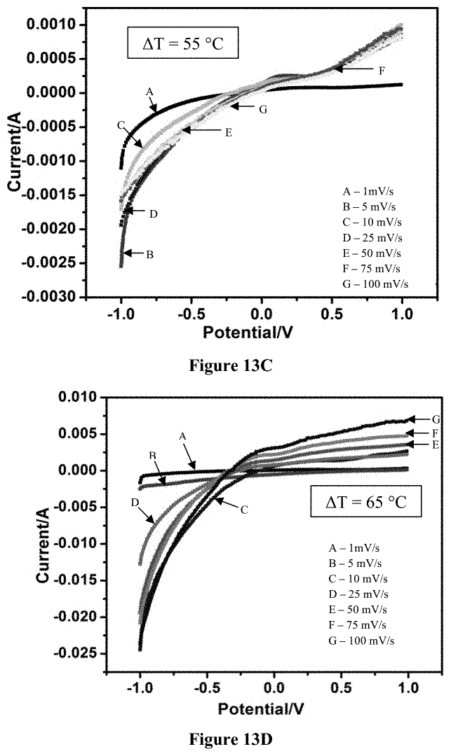

The energy harvesting device (200) was subjected to Linear Sweep Voltammetry (LSV) scan at varying values of ΔT, wherein LSV scan at ΔT=60° C. is as shown in FIG. 13A; at ΔT=70° C., 40° C. and room temperature as shown in FIG. 13B; at ΔT=55° C. as shown in FIG. 13C and at ΔT=65° C. as shown in FIG. 13D. The LSV scan was performed at loads in the range of 1 mV/s to 100 mV/s.

From the I-V profile in FIG. 13A, it is clear that the maximum current obtained from the device is 6 mA at 100 mV/s and the maximum voltage output is 1V at all loads. From potential −1 to 1V, the current is very small (2 mA) and constant at 1 mV/s. The rationale behind this constant plateau in current (at 1 mV/s) is due to the continuous flow of electrons required to maintain a charged electric double layer at the electrode/electrolyte interface. Beyond 1V, electrochemical redox reaction occurs at the electrode/electrolyte interface leading to a rapid increase in current. These results indicate that copper coated graphene due to its high conductivity increases the phononic vibrations and electron mobility at graphene/electrolyte interface.

### 5b) Mass Transfer Coefficient:

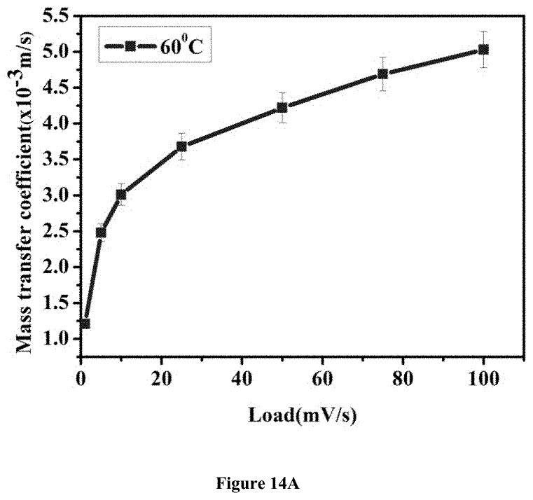

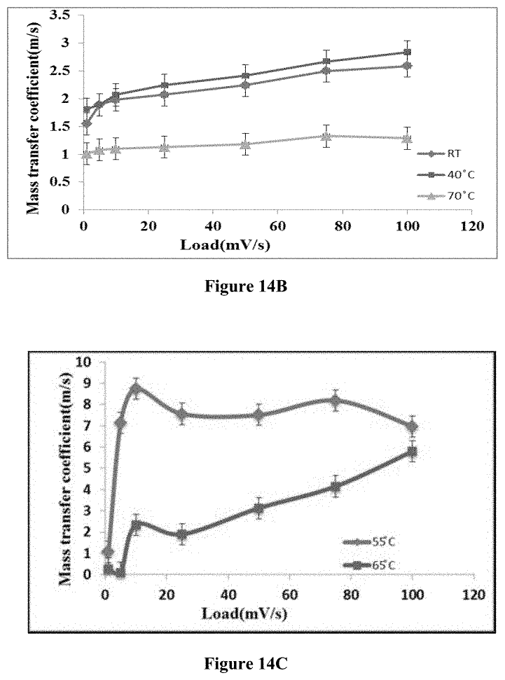

FIG. 14A illustrates average mass transfer coefficient of the energy harvesting device (200) at different loads in the range of 1 mV/s to 100 mV/s at ΔT=60° C. Using equation as stated in Experiment 2h, the lower limit of the mass transfer coefficient of the energy harvesting device (200) is calculated to be 3.47×10⁻³ m/s at ΔT=60° C. This value is higher than a single graphene based thermocell that gave average mass transfer coefficient of 5.41×10⁻⁶ m/s at ΔT=50° C., thus showing that the thermocells connected in series gave a better performance than single graphene thermocells.

The average transfer mass transfer coefficient of the energy harvesting device (200) at ΔT=40° C. and 70° C. is as illustrated in Table 8 and FIG. 14B. The average transfer mass transfer coefficient of the energy harvesting device (200) at ΔT=55° C. and 65° C. is C is as illustrated in Table 9 and FIG. 14C.

Table 8 provides the lower limit of Mass transfer coefficient at RT and ΔT=40° C., 70° C.

| | ΔT | | |
|---|---|---|---|
| Load | RT | 40° C. | 70° C. |
| 1 mV/s | 1.55 × 10⁻⁵ | 1.81 × 10⁻⁶ | 1.01 × 10⁻⁴ |
| 5 mV/s | 1.89 × 10⁻⁵ | 1.89 × 10⁻⁶ | 1.08 × 10⁻⁴ |
| 10 mV/s | 1.98 × 10⁻⁵ | 2.07 × 10⁻⁶ | 1.10 × 10⁻⁴ |
| 25 mV/s | 2.07 × 10⁻⁵ | 2.24 × 10⁻⁶ | 1.13 × 10⁻⁴ |
| 50 mV/s | 2.24 × 10⁻⁵ | 2.41 × 10⁻⁶ | 1.18 × 10⁻⁴ |
| 75 mV/s | 2.50 × 10⁻⁵ | 2.67 × 10⁻⁶ | 1.33 × 10⁻⁴ |
| 100 mV/s | 2.59 × 10⁻⁵ | 2.84 × 10⁻⁶ | 1.29 × 10⁻⁴ |

ΔT

| Load | 55° C. | 65° C. |
|---|---|---|
| 1 mV/s | 1.07 × 10⁻⁵ | 2.79 × 10⁻⁵ |
| 5 mV/s | 7.14 × 10⁻⁵ | 8.37 × 10⁻⁶ |
| 10 mV/s | 8.74 × 10⁻⁵ | 2.34 × 10⁻⁴ |
| 25 mV/s | 7.56 × 10⁻⁵ | 1.90 × 10⁻⁴ |
| 50 mV/s | 7.51 × 10⁻⁵ | 3.13 × 10⁻⁴ |
| 75 mV/s | 8.19 × 10⁻⁵ | 4.15 × 10⁻⁴ |
| 100 mV/s | 6.97 × 10⁻⁵ | 5.80 × 10⁻⁴ |

### 5c) Electrochemical Impedance Spectroscopy (EIS):

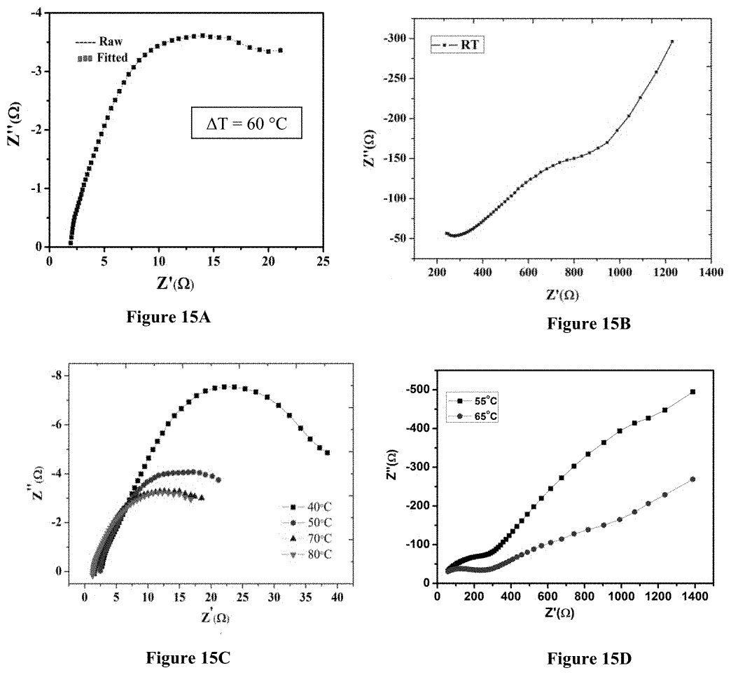

The energy harvesting device (200) was subjected to Electrochemical Impedance Spectroscopy (EIS). The Nyquist plot of the device at ΔT=60° C. was recorded employing Zahner Zennium electrochemical workstation as provided in FIG. 15A.

The Nyquist plot of the device at ΔT=room temperature is provided in FIG. 15B; at ΔT=40° C., 50° C., 70° C. and 80° C. is provided in FIG. 15C and at ΔT=55° C. and 65° C. is provided in FIG. 15D.

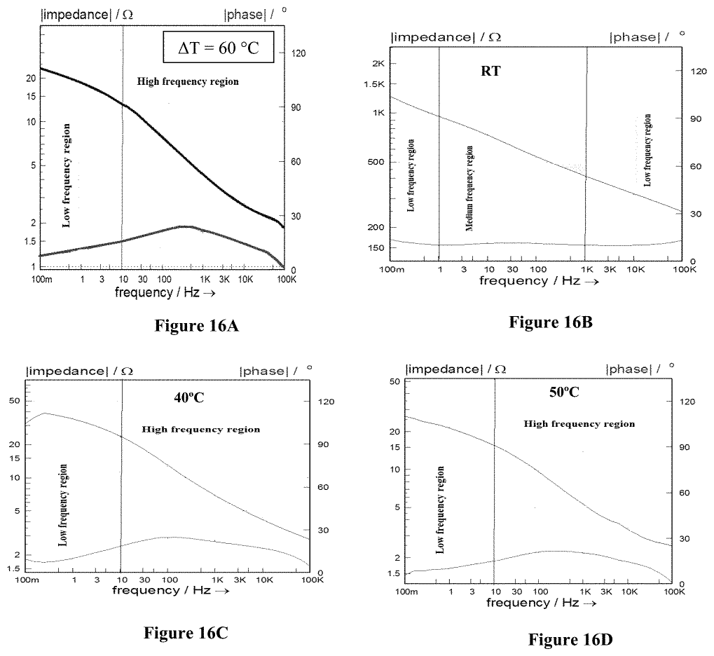

The corresponding bode plots were plotted to represent the processes occurring in the device due to supply of thermal energy at ΔT=60° C. is provided in FIG. 16A. The bode plot showed two time constants (R-Cs) as represented by two regions, which correspond to i) semicircle at high frequency region (100 kHz-10 Hz) that represents charge transfer resistance (R₁) ii) tailing off at low frequency region (10 Hz-100 mHz) that indicates mass transfer resistance (R₂).

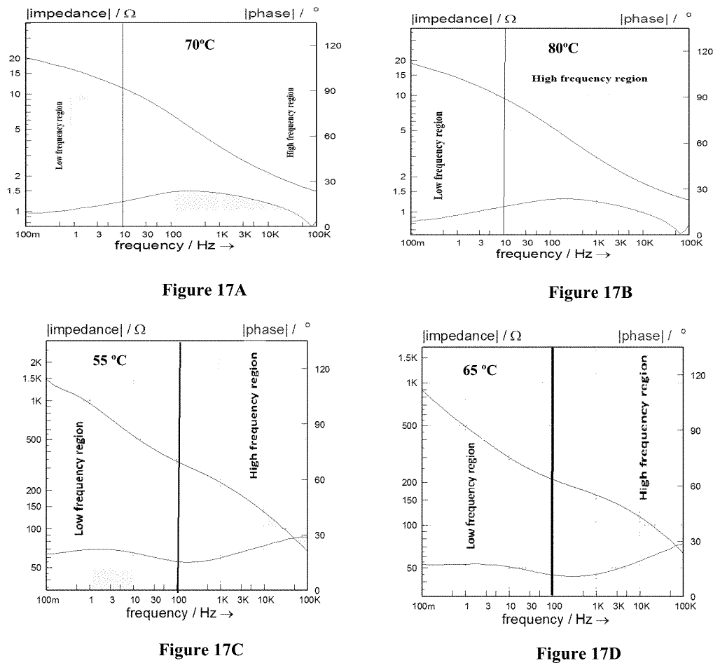

The bode plots of the device at ΔT=room temperature is provided in FIG. 16B; ΔT=40° C. is provided in FIG. 16C and ΔT=50° C. is provided in FIG. 16D. The bode plots of the device at ΔT=70° C. is provided in FIG. 17A; ΔT=80° C. is provided in FIG. 17B; ΔT=55° C. is provided in FIG. 17C and ΔT=65° C. is provided in FIG. 17D.

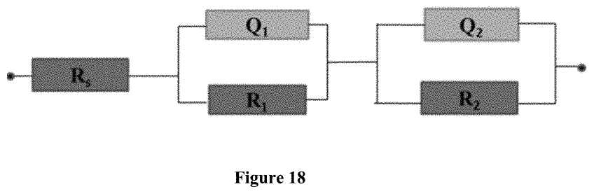

FIG. 18 illustrates fitted equivalent circuit for the bode and Nyquist plots for the energy harvesting device 200 at ΔT=60° C., fitted using Zman software (Rₛ−R₁|Q₁−R₂|Q₂).

The equivalent circuit and CPE parameters of Nyquist plot for RT and ΔT=40° C., 50° C., 70° C., 80° C. are as given in Table 10. The equivalent circuit and CPE parameters of Nyquist plot for thickness 20 and 30 microns at ΔT=60° C. is illustrated in Table 11.

For ΔT=60° C., the series resistance (Rₛ) of the device was 1.90Ω which corresponds to the resistances at electrode/electrolyte interface. The charge transfer resistance (R₁) of the device for ΔT=60° C. was 5.12Ω, that could be attributed by the electron transfer reaction at electrode/electrolyte interface. The mass transfer resistance (R₂) for ΔT=60° C. was found to be 21Ω and could be attributed to the transport of Ferro/Ferricyanide ions from bulk to the electrode/electrolyte interface.

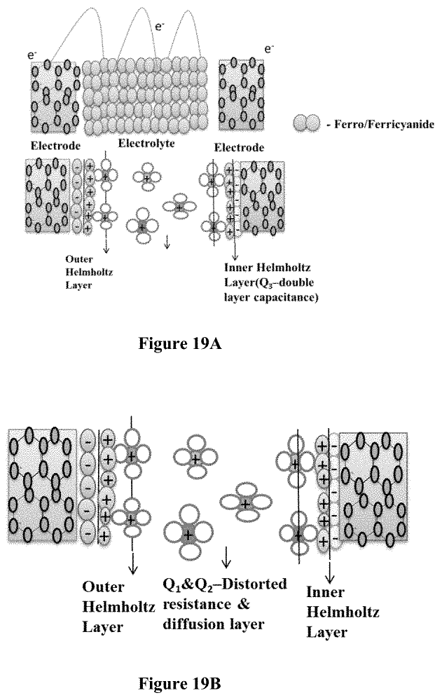

FIG. 19A illustrates constant phase element at electrode/electrolyte interface at room temperature. FIG. 19B illustrates constant phase element at electrode/electrolyte interface for ΔT=40° C., 50° C., 70° C., 80° C.

Table 10 provides the equivalent circuit and CPE parameters of Nyquist plot for RT and ΔT=40° C., 50° C., 70° C., 80° C.

TABLE 10
provides the equivalent circuit and CPE parameters of Nyquist plot for
RT and ΔT = 40° C., 50° C., 70° C., 80° C.

| | | | Constant | | |
|---|---|---|---|---|---|
| | | | phase | | |
| S. | | | element(CPE) | CPE | |
| No | ΔT | Equivalent circuit | Ω⁻¹S^{a} | Parameter(a) | Description |
| 1 | RT | [symbol] | Qy₁ = 4.986 μ Qy₂ = 0.3 m Qy₃ is 6.6 m | Qa₂ = 0.4 Qa₂ = 0.3 Qa₂ = 0.9 | diffusion layer capacitance distorted resistance Inner layer capacitance |
| 2 | 40° C. | [symbol] | Qy₁ = 4.14 m Qy₂ = 14.4 m | Qa₁ = 0.6 Qa₂ = 0.2 | diffusion layer capacitance distorted resistance |
| 3 | 50° C. | [symbol] | Qy₁ = 5.46 m Qy₂ = 23.4 m | Qa₁ = 0.5 Qa₂ = 0.3 | diffusion layer capacitance distorted resistance |
| 4 | 55° C. | [symbol] | Qy₁ = 0.052 m Qy₂ = 0.52 m | Qa₁ = 0.4 Qa₂ = 0.4 | diffusion layer capacitance |
| 5 | 65° C. | [symbol] | Qy₁ = 0.025 m Qy₂ = 1.057 m | Qa₁ = 0.4 Qa₂ = 0.4 | diffusion layer capacitance |
| 6 | 70° C. | [symbol] | Qy₁ = 5.47 m Qy₂ = 26.6 m | Qa₁ = 0.6 Qa₂ = 0.3 | diffusion layer capacitance distorted resistance |
| 7 | 80° C. | [symbol] | Qy₁ = 9.04 m Qy₂ = 22.6 m | Qa₁ = 0.7 Qa₂ = 0.3 | diffusion layer capacitance distorted resistance |

Table 11 provides the equivalent circuit and CPE parameters of Nyquist plot for thickness 20 and 30 microns at ΔT=60° C.

TABLE 11
provides the equivalent circuit and CPE parameters of Nyquist plot for
thickness 20 and 30 microns at ΔT = 60° C.

| | | | Constant | | |
|---|---|---|---|---|---|
| | | | phase | | |
| S. | Thickness | | element(CP | CPE | |
| No | in microns | Equivalent circuit | Ω⁻¹S^{a} | Parameter(a) | Description |
| 1 | 20 | [symbol] | Qy₁ = 54.14 m Qy₂ = 94.4 m | Qa₁ = 0.3 Qa₂ = 0.2 | distorted resistance |
| 2 | 30 | [symbol] | Qy₁ = 155.46 m Qy₂ = 103.4 m | Qa₁ = 0.3 Qa₂ = 0.3 | distorted resistance |

### 5d) Power Density (Pmax/A) and Current Density (Jsc):

The energy harvesting device (200) as prepared in Experiment 4, was subjected to measurement of power and current density variation at different loads, as summarized in Table 12 (ΔT=60° C.) and Table 13 (ΔT=40° C., 70° C.).

The maximum current and power density obtained were 98.3 A/m² and 49.2 W/m² at ΔT=60° C., as shown in Table 12. The power and current density values obtained for the energy harvesting device (200) was much higher than a single graphene thermocell (for graphene thermocell, maximum current density and power density obtained were 0.63 A/m² and 0.18 W/m², respectively at ΔT=60° C. as provided in experiment 3g).

Table 12 provides the power and current density values of the device at ΔT=60° C.

| Load in | J_{sc} | E_{oc} | I_{sc} | Pₘₐₓ | Pₘₐₓ/A |
|---|---|---|---|---|---|
| mV/S | (mA/m²) | (V) | (mA) | (mW) | (mW/m²) |
| 1 | 3916.6 | 0.5 | 0.47 | 0.235 | 1958.3 |
| 5 | 12583.3 | 0.5 | 1.51 | 0.755 | 6291.6 |
| 10 | 8250.0 | 0.5 | 0.99 | 0.495 | 4125.0 |
| 25 | 4500.0 | 0.5 | 0.54 | 0.270 | 2250.0 |
| 50 | 2916.6 | 0.5 | 0.35 | 0.175 | 1458.3 |
| 75 | 9250.0 | 0.5 | 1.11 | 0.550 | 4583.3 |
| 100 | 98333.3 | 0.5 | 11.8 | 5.900 | 49166.6 |

Table 13 provides the power and current density plot of the device at RT and ΔT=40° C. and 70° C.

TABLE 13
provides the power and current density plot of the device at RT and
ΔT = 40° C. and 70° C.

| | Load in | J_{sc} | E_{oc} | I_{sc} | Pₘₐₓ | Pₘₐₓ/A |
|---|---|---|---|---|---|---|
| ΔT | mV/s | (mA/m²) | (V) | (mA) | (mW) | (mW/m²) |
| RT | 1 | 159.16 | 0.6 | 0.0191 | 0.0114 | 95.0 |
| | 5 | 171.60 | 0.6 | 0.0206 | 0.0123 | 102.5 |
| | 10 | 161.66 | 0.6 | 0.0194 | 0.0116 | 96.6 |
| | 25 | 62.50 | 0.6 | 0.0075 | 0.0045 | 37.5 |
| | 50 | 104.16 | 0.6 | 0.0125 | 0.0075 | 62.5 |
| | 75 | 120.00 | 0.6 | 0.0144 | 0.0086 | 71.6 |
| | 100 | 432.50 | 0.6 | 0.0519 | 0.0311 | 257.02 |
| 40° C. | 1 | 4.75 | 0.5 | 0.00057 | 0.00028 | 2.33 |
| | 5 | 7.91 | 0.5 | 0.00095 | 0.00047 | 3.92 |
| | 10 | 10.25 | 0.5 | 0.00123 | 0.00062 | 5.16 |
| | 25 | 16.25 | 0.5 | 0.00195 | 0.00097 | 8.08 |
| | 50 | 18.50 | 0.5 | 0.00222 | 0.00111 | 9.25 |
| | 75 | 23.00 | 0.5 | 0.00276 | 0.00138 | 11.5 |
| | 100 | 26.50 | 0.5 | 0.00318 | 0.00159 | 13.3 |
| 70° C. | 1 | 1133.3 | 0.75 | 0.136 | 0.068 | 566.6 |
| | 5 | 1225.0 | 0.75 | 0.147 | 0.074 | 616.6 |
| | 10 | 1066.6 | 0.75 | 0.128 | 0.064 | 533.3 |
| | 25 | 825.0 | 0.75 | 0.099 | 0.049 | 408.3 |
| | 50 | 725.0 | 0.75 | 0.087 | 0.044 | 366.6 |
| | 75 | 841.6 | 0.75 | 0.101 | 0.050 | 416.6 |
| | 100 | 1150.0 | 0.75 | 0.138 | 0.069 | 575.0 |

### 5e) Energy Conversion Efficiency (η) and Relative Carnot Efficiency (ηᵣ):

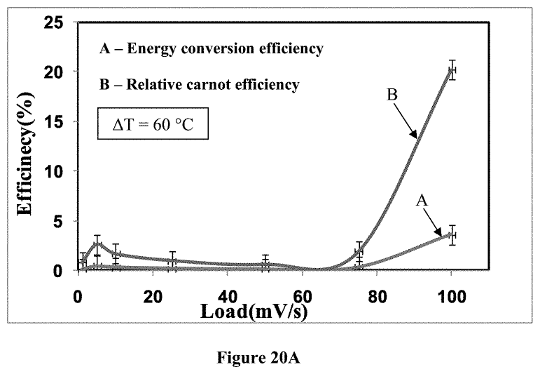

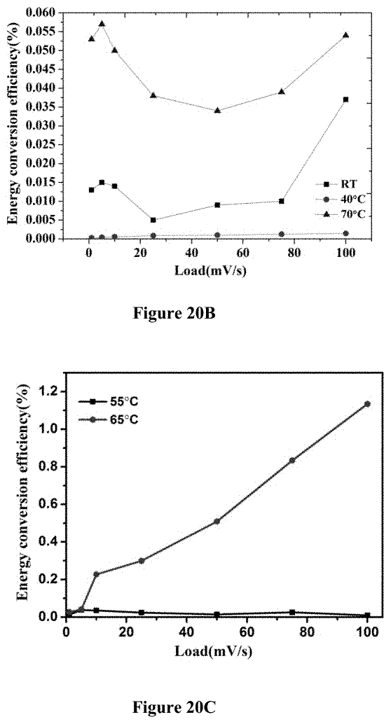

The energy conversion efficiency of the energy harvesting device (200) was calculated for different loads by using the equation as in Experiment 3i, graphically represented in FIG. 20A (ΔT=60° C.), FIG. 20B (ΔT=40° C. and 70° C.) and FIG. 20C (ΔT=55° C. and 65° C.). The parameters employed were VOC=0.5V, I_{SC}=11.8 mA, A=0.00012 m², =0.57 W/m/K, ΔT=60° C., d=10 cm. The maximum energy conversion efficiency (200) of the energy harvesting device (200) was 3.59% obtained at ΔT=60° C. at a load of 100 mV/s, which was much higher compared to the single graphene thermocell (for graphene thermocell, the maximum energy conversion efficiency for the thermocell was 1.55% at load of 1 mV/s, as provided in Experiment 3i).

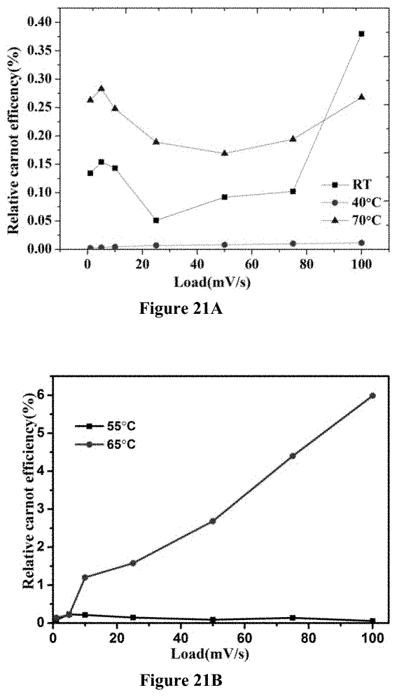

The relative carnot efficiency of the energy harvesting device (200) was calculated for different loads from 1 mV/s to 100 mV/s, by using the equation as in Experiment 3(j), graphically represented in FIG. 20A (ΔT=60° C.), FIG. 21A (ΔT=40° C. and 70° C.) and FIG. 21B (ΔT=55° C. and 65° C.). The maximum relative carnot efficiency for the energy harvesting device (200) was found to be 20.2% at ΔT=60° C., which is much higher compared to the single graphene thermocell (for graphene thermocell, the resulting average maximum relative carnot efficiency was 1.31% at ΔT=50° C., as provided in Experiment 3j).

Table 14 provides the power and current density plot of the device at ΔT=55° C. and 65° C.

TABLE 14
provides the power and current density plot of the device
at ΔT = 55° C. and 65° C.

| | Load in | Jsc | Eoc | Isc | Pmax | Pmax/A |
|---|---|---|---|---|---|---|
| ΔT | mV/s | (mA/m²) | (V) | (mA) | (mW) | (mW/m²) |
| 55° C. | 1 | 416.6 | 0.4 | 0.050 | 0.020 | 166.6 |
| | 5 | 1183.3 | 0.4 | 0.142 | 0.056 | 466.6 |
| | 10 | 1108.3 | 0.4 | 0.133 | 0.053 | 441.6 |
| | 25 | 750.0 | 0.4 | 0.090 | 0.036 | 300.0 |
| | 50 | 450.0 | 0.4 | 0.054 | 0.022 | 183.3 |
| | 75 | 708.3 | 0.4 | 0.085 | 0.034 | 283.3 |
| | 100 | 300.0 | 0.4 | 0.036 | 0.014 | 116.6 |
| 65° C. | 1 | 566.6 | 0.7 | 0.068 | 0.047 | |
| | 5 | 866.6 | 0.7 | 0.104 | 0.072 | 600.0 |
| | 10 | 4808.3 | 0.7 | 0.577 | 0.403 | 3358.3 |
| | 25 | 6325.0 | 0.7 | 0.759 | 0.531 | 4425.0 |
| | 50 | 10766.6 | 0.7 | 1.292 | 0.904 | 7533.3 |
| | 75 | 17650.0 | 0.7 | 2.118 | 1.482 | 12350.0 |
| | 100 | 24016.6 | 0.7 | 2.882 | 2.014 | 16783.3 |

Table 15 provides the energy conversion efficiency at RT and ΔT=40° C. and 70° C.

| | ΔT | | |
|---|---|---|---|
| | Room | | |
| Load | temperature | 40° C. | 70° C. |
| 1 mV/s | 0.013 | 0.00026 | 0.053 |
| 5 mV/s | 0.015 | 0.00043 | 0.057 |
| 10 mV/s | 0.014 | 0.00056 | 0.050 |
| 25 mV/s | 0.005 | 0.00089 | 0.038 |
| 50 mV/s | 0.009 | 0.00101 | 0.034 |
| 75 mV/s | 0.010 | 0.00126 | 0.039 |
| 100 mV/s | 0.037 | 0.00145 | 0.054 |

Table 16 provides the energy conversion at RT and ΔT=55° C. and 65° C.

ΔT

| Load | 55° C. | 65° C. |
|---|---|---|
| 1 mV/s | 0.0132 | 0.0267 |
| 5 mV/s | 0.0377 | 0.0409 |
| 10 mV/s | 0.0353 | 0.2271 |
| 25 mV/s | 0.0239 | 0.2987 |
| 50 mV/s | 0.0143 | 0.5085 |
| 75 mV/s | 0.0255 | 0.8336 |
| 100 mV/s | 0.0095 | 1.134 |

Table 17 provides the relative carnot effienciency at RT and ΔT=40° C. and 70° C.

| | ΔT | | |
|---|---|---|---|
| | Room | | |
| Load | temperature | 40° C. | 70° C. |
| 1 mV/s | 0.134 | 0.0021 | 0.263 |
| 5 mV/s | 0.154 | 0.0034 | 0.283 |
| 10 mV/s | 0.143 | 0.0044 | 0.248 |
| 25 mV/s | 0.051 | 0.0070 | 0.189 |
| 50 mV/s | 0.092 | 0.0080 | 0.169 |
| 75 mV/s | 0.102 | 0.0100 | 0.194 |
| 100 mV/s | 0.380 | 0.0115 | 0.268 |

Table 18 provides the relative carnot efficiency at ΔT=55° C. and 65° C.

ΔT

| Load | 55° C. | 65° C. |
|---|---|---|
| 1 mV/s | 0.080 | 0.1412 |
| 5 mV/s | 0.228 | 0.2161 |
| 10 mV/s | 0.213 | 1.199 |
| 25 mV/s | 0.144 | 1.577 |
| 50 mV/s | 0.086 | 2.684 |
| 75 mV/s | 0.136 | 4.401 |
| 100 mV/s | 0.057 | 5.987 |

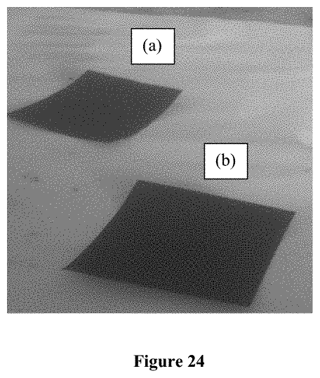

Table 19 provides the calculated energy efficiency of the fabricated thermocell at ΔT=600° C. at scan rates 1mV/s, 50mV/s, 100mV/S and 200mV/s for (a) and (b) in FIG. 24.

| scan | | |
|---|---|---|
| rate | Thickness 20 μm | 30 μm |
| 1 | 0.0141 | 0.0477 |
| 50 | 0.0393 | 1.12022 |
| 100 | 0.1579 | 0.1184 |
| 200 | 0.0476 | 0.0231 |

Table 20 provides the relative Carnot effieciency for the energy conversion by the thermocell at ΔT=600Cat scan rates 1mV/s, 50mV/s, 100V/s and 200mV/s for (a) and (b) in FIG. 24

| scan rate | Thickness 20 μm | Thickness 30 μm |
|---|---|---|
| 1 | 0.01432 | 0.0484 |
| 50 | 0.0399 | 1.1376 |
| 100 | 0.1604 | 0.1202 |
| 200 | 0.0483 | 0.023 |

### 5f) Degradation Studies:

The degradation studies were done to understand the decline in the efficiency of the energy harvesting device (200) after crossing the value of ΔT=60° C. The degradation analysis was done by performing X-ray diffraction and cyclic voltammetry (CV), as provided below.

### (i) X-Ray Diffraction (XRD) Analysis:

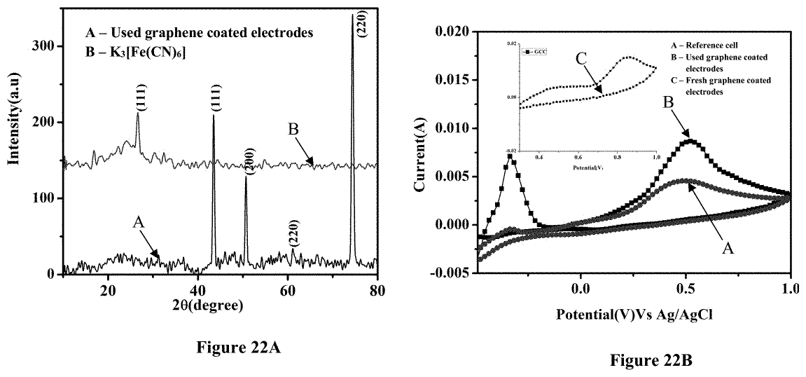

The energy harvesting device (200) comprising used graphene coated electrodes was subjected to X-ray diffraction analysis. The source consisted of Cu Kα radiation (λ=1.54 Å). Three peaks centered at 43.4°, 50.7° and 74.4° assigned to (111), (200) and (220) crystal planes of metallic copper, could be clearly observed in the XRD pattern of used graphene coated electrodes of the energy harvesting device (200) as shown in FIG. 22A. The XRD analysis showed the presence of peaks due to the formation of Cu₂O on the electrode surface. The low peak intensity at 20=61.1° corresponds to the Cu₂O, which confirmed the oxidation of copper foil due to corrosion. The XRD pattern of agar-Ferro/Ferricyanide electrolyte used as shown in FIG. 22A indicated peaks corresponding to Ferro/Ferricyanide at 20 values of 26.6° and peak corresponding to agar film at 17.0°, which confirmed the presence of electrolyte without any degradation. The degradation studies showed that the corrosion of copper foil was caused by graphene and water vapour rather than by the electrolyte.

### (ii) Cyclic Voltammetry (CV) Studies:

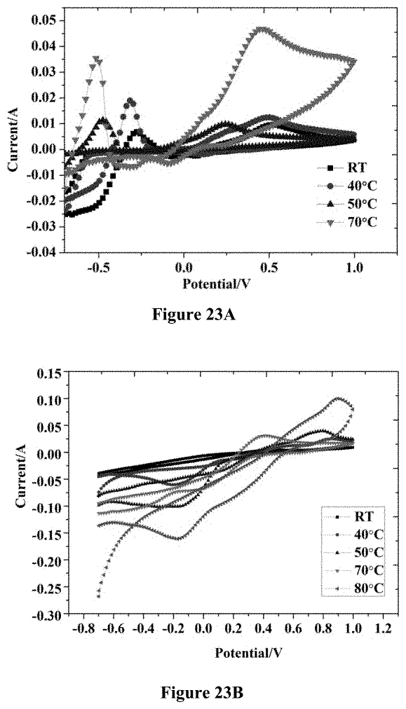

The energy harvesting device (200) comprising used graphene coated electrodes and a reference cell comprising bare copper electrodes (BC) were subjected to cyclic voltammetry analysis, as shown in FIG. 22B, wherein 1M of potassium ferricyanide was employed as electrolyte at a scan rate of 25 mV/s and temperature difference of ΔT=60° C. The cyclic voltammetry analysis of the reference cell comprising bare copper electrodes showed reduction peak of Fe(III)/Fe(II) at 0.1V and oxidation peak of Fe(II)/Fe(III) at 0.55V vs Ag/AgCl, wherein the peak at −0.3V corresponds to oxidation of Cu into Cu₂O. The cyclic voltammetry analysis of used graphene coated electrodes of the energy harvesting device (200) showed identical peaks as that of bare copper electrode of the reference cell, but with reduced peak height due to presence of thin graphene layer. The cyclic voltammetry analysis of fresh electrodes of the energy harvesting device (200) showed one oxidation peak at 0.85V corresponding to Fe(II)/Fe(III), wherein the copper oxidation peak disappeared, as shown in the inset of FIG. 22B. The cyclic voltammogram of a reference electrode (bare copper) at ΔT=40° C., 50° C. and 70° C. is as shown in FIG. 23B.

Further, the diffusion coefficient (D) of the electrolyte was calculated using Randles-Sevcik equation[7],

iₚ=(2.69×10⁵)n^{3/5}AD^{1/2}v^{1/2}C

where, iₚ is the peak current in amperes, n is the number of electrons, A is the area of the electrode in cm², D is the diffusion co-efficient in cm²/s, C is the concentration of the species in mol/cm³, v is the scan rate in mV/s.

The diffusion coefficient (D) of the bare copper electrodes (BC) of the reference cell and the used graphene coated electrodes of the energy harvesting device (200) were similar in value whereas fresh electrodes of the energy harvesting device (200) showed approximately 1.26 times higher value. This indicates peeling of graphene coating on prolonged usage of the device and the copper getting exposed to the electrolyte solution.

The water present in the device vaporizes beyond ΔT=60° C., thereby causing water vapour accumulation inside the device. Due to this, cell opening and loss of thermal energy occurs via absorption by water vapour that leads to oxidation of copper and thereby reduction in the performance of the device.

### TECHNICAL ADVANCEMENTS

The present disclosure described herein above has several technical advantages including, but not limited to, the realization of a graphene thermocell based energy harvesting device, wherein the device:
provides improved performance by reducing ohmic overpotential and mass transfer overpotential;
provides improved energy efficiency with respect to carnot efficiency; and
is cost effective in comparison to conventional cells comprising platinum based electrodes.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments fully reveal the general nature of the embodiments herein that others can, by applying current knowledge, readily modify and/or adapt for various applications. Such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure, as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation

1. A graphene based thermocell comprising:
a first electrode;
a second electrode; and
a redox electrolyte,
characterized in that at least a portion of at least one of said first electrode and said second electrode is coated with graphene, wherein the temperature difference between said first electrode and said second electrode is in the range of 40° C. to 80° C.

2. The thermocell as claimed in claim 1, wherein the redox electrolyte is sandwiched between the first electrode and the second electrode.

3. The thermocell as claimed in claim 1, wherein the redox electrolyte is potassium ferricyanide solution.

4. The thermocell as claimed in claim 3, wherein the concentration of said potassium ferricyanide solution is 1 molar.

5. The thermocell as claimed in claim 1, wherein the temperature difference between said first electrode and said second electrode is 50° C.

6. The thermocell as claimed in claim 1, wherein the second electrode is maintained at a temperature in the range of 40° C. to 80° C. and the first electrode is maintained at a temperature in the range of 0° C. to 5° C.

7. The thermocell as claimed in claim 1, having maximum energy conversion efficiency of 1.55% at a load of 1 mV/s, maximum current density of 0.63 A/m², maximum power density of 0.18 W/m² and average maximum relative carnot efficiency of 1.3%.

8. The thermocell as claimed in claim 1, is configured to exhibit an average heterogenous rate constant (Kₕₑₜ^{ohmic}) of 9.33×10¹³ s⁻¹ for ohmic process and an average heterogenous rate constant (Kₕₑₜ^{mt}) of 1.43×10¹⁶ s⁻¹ for mass-transfer process.

9. The thermocell as claimed in claim 1, wherein said first electrode and said second electrode, are partially or wholly copper electrodes, and wherein at least a portion of at least one of said first electrode and said second electrode is coated with graphene.

10. An energy harvesting device comprising a plurality of graphene based thermocells,
wherein each of the plurality of the graphene based thermocell comprises:
a first electrode;
a second electrode; and
a redox electrolyte,
characterized in that at least a portion of at least one of said first electrode and said second electrode is coated with graphene, wherein the temperature difference between said first electrode and said second electrode is in the range of 40° C. to 80° C.

11. The energy harvesting device as claimed in claim 10, wherein said plurality of graphene based thermocells are electrically connected in series such that each of the plurality of graphene based thermocells is electrically connected to at least one adjacent thermocell, or wherein the temperature difference between said first electrode and said second electrode is 50° C.

12. The energy harvesting device as claimed in claim 10 having maximum energy conversion efficiency of 3.59%, maximum relative carnot efficiency of 20.2%, maximum current density of 98.3 A/m² and maximum power density of 49.2 W/m².

13. A process for manufacturing a graphene based thermocell, said process comprising the following steps:
(i) oxidizing graphite to obtain graphene oxide;
(ii) reacting the graphene oxide with a reducing agent, to obtain graphene nanoparticles;
(iii) mixing the graphene nanoparticles with water to obtain a paste;
(iv) coating said paste on at least a portion of a first copper sheet, to obtain a first electrode;
(v) coating said paste on at least a portion of a second copper sheet, to obtain a second electrode;
(vi) contacting said first electrode and said second electrode with a redox electrolyte to obtain a cell, wherein the redox electrolyte is in between said first electrode and said second electrode; and
(vii) maintaining a temperature difference in the range of 40° C. to 80° C., between said first electrode and said second electrode in the cell, and providing electrical connections to obtain the graphene based thermocell.

14. The process as claimed in claim 13, wherein step (i) of oxidation comprises reacting graphite with sodium nitrite, sulphuric acid and potassium permanganate.

15. The process as claimed in claim 13, wherein the reducing agent is hydrazine hydrate.

16. The process as claimed in claim 13, wherein said redox electrolyte is prepared by mixing agar powder with water and potassium ferricyanide, at a temperature in the range of 75° C. to 85° C.

17. The process as claimed in claim 13, wherein the temperature difference between said first electrode and said second electrode is 50° C.

18. The process as claimed in claim 13, wherein steps (i) to (vii) are repeated to obtain a plurality of graphene based thermocells.

19. The process as claimed in claim 18, wherein said plurality of graphene based thermocells are electrically connected in series to obtain an energy harvesting device, wherein each of the plurality of graphene based thermocells is electrically connected to at least one adjacent thermocell.
